(19) United States
(12) Patent Application Publication
(10) Pub. No.: US 2018/0320420 A1
(43) Pub. Date: Nov. 8, 2018

(54) METHOD TO DETECT END-OF-LIFE IN LATCHES

(71) Applicant: Ford Global Technologies, LLC, Dearborn, MI (US)

(72) Inventors: Erin Rose Briggs, Detroit, MI (US); Muhammad Omer Khan, Ypsilanti, MI (US); Kosta Papanikolaou, Huntington Woods, MI (US); Livianu Dorin Puscas, Rochester Hills, MI (US); Christopher Matthew Radjewski, Macomb, MI (US)

(73) Assignee: Ford Global Technologies, LLC

(21) Appl. No.: 15/586,984

(22) Filed: May 4, 2017

(51) Int. Cl. E05B 81/66; E05B 81/68; E05B 17/22; E05B 81/14; E05B 15/04; E05B 17/00; E05B 39/04; G07C 9/00

(52) U.S. Cl. CPC E05B 81/66; E05B 81/68; E05B 17/226; G07C 9/00896; E05B 15/04; E05B 17/0062; E05B 39/04; E05B 81/14

(57) ABSTRACT

A door latch system for vehicle doors, deck lids, hatches, hoods, or the like includes a latch. The latch has a predicted life that may be based on a number of times the latch is used. A sensor that generates a signal that can be used to determine if the latch has reached the predicted life and/or if the latch is approaching the predicted life and/or if the latch has exceeded the predicted life. The system may include a controller that causes a display in a vehicle interior to display an end-of-life signal.

### FIELD OF THE INVENTION

The present invention generally relates to vehicle door latches and in particular to a counting mechanism that is utilized to determine if a latch is reaching its end-of-life.

### BACKGROUND OF THE INVENTION

Motor vehicles typically include latch mechanisms that selectively retain the vehicle doors in a closed position. Existing latches may include a rotating claw that is configured to engage a striker and retain the door in a closed position when the latch is in a latched configuration. A pawl selectively prevents rotation of the claw from an engaged position to a disengaged position. In mechanical latches, the pawl may be mechanically connected to a movable door handle by linkage such that movement of the door handle shifts the pawl from an engaged position to a disengaged position to unlatch the latch. Powered latches have also been developed. Powered latches may include an electrically powered actuator that shifts the pawl from the engaged position to the disengaged position, thereby permitting movement of the claw when the powered latch is unlatched.

Due to wear encountered during operation of the latch, latches may fail after the latch has been used for a period of time. Failure due to wear may occur in both mechanical latches and powered latches.

### SUMMARY OF THE INVENTION

One aspect of the present disclosure is a latch system for vehicle doors, deck lids, hatches, hoods, or other movable enclosures. The latch system includes a latch that is configured to shift between latched and unlatched configurations. The latch has a predicted life that may be based on a number of times the latch is used. The latch system further includes a sensor that generates signals that can be used to determine how many times the latch has been used. The system generates an end-of-life signal when the latch has reached the predicted life and/or when the latch is approaching the predicted life and/or when the latch has exceeded the predicted life. The system may include a controller that is operably connected to the sensor. The controller may be configured to alert a user that the latch is approaching an end-of-life condition, and/or that the latch has reached an end-of-life condition. The alert may comprise an audio alert and/or it may comprise a visual display (message) that is provided on a display screen in a vehicle interior.

Another aspect of the present disclosure is a door latch system for vehicle doors. The system includes a latch for vehicle doors. The latch has latched and unlatched configurations. In use, the latch cycles between the latched and unlatched configurations. The system includes a counting device that counts the number of cycles of the latch and/or the number of configuration changes from one of the latched and unlatched states to the other of the latched and unlatched states. The system further includes a controller that is operably connected to the counting device. The controller is configured to generate an end-of-life signal indicating that the latch has reached an end-of-life condition and/or is approaching an end-of-life condition. The controller generates the end-of-life signal based on predefined criteria. The predefined criteria may comprise at least one of an allowable number of cycles of the latch and/or an allowable number of configuration changes of the latch.

Another aspect of the present disclosure is a vehicle latch system including a vehicle door latch and a sensor that detects latch operations. The latch operations may include latching and/or unlatching of the latch. The system further includes a controller that is configured to generate an end-of-life signal if the controller determines that a predefined number of latch operations have occurred.

Embodiments of the first aspect of the invention can include any one or a combination of the following features:
The latch may include a rotatable claw that is configured to engage a striker, and a pawl that engages the claw and prevents rotation of the claw when the latch is in a latched configuration. The sensor may be configured to detect movement and/or position of at least one of the claw and the pawl.
The latch may include a rotatable claw that is configured to engage a striker, and a pawl that engages the claw and prevents rotation of the claw when the latch is in a latched configuration. The sensor may be configured to detect engagement and/or disengagement of the pawl with the claw.
The door latch system may include a controller that is operably connected to the sensor, and the controller may be configured to generate an end-of-life signal.
The door latch system may include a display that is operably connected to the controller, and the controller may be configured to cause the display to display a message indicating that the latch has reached its end-of-life and/or that the latch is approaching its end-of-life.
The latch may include a rotatable claw that is configured to engage a striker, and a pawl that engages the claw and prevents rotation of the claw when the latch is in a latched configuration. The latch may include an electrically-powered actuator that is configured to shift the pawl between latched and unlatched positions to thereby unlatch the latch. The sensor may comprise a switch that detects engagement of the pawl with the claw and/or movement and/or position of the claw and/or the pawl.
The latch may include a rotatable claw that is configured to engage a striker, and a pawl that engages the claw and prevents rotation of the claw when the latch is in a latched configuration. The latch may include a spring that is operably connected to the claw and/or the pawl such that spring cycles upon movement of the claw and/or the pawl. The spring may be configured to fail after a predefined number of cycles, and failure of the spring causes actuation of the sensor.
The spring may comprise a torsion spring that is operably connected to the claw or the pawl.
The spring may comprise a compression spring that is operably connected to the claw or the pawl.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a schematic plan view of a vehicle including a plurality of doors and door latch systems;

FIG. 2 is a partially schematic isometric view of a powered latch showing sensor locations for counting latch cycles;

FIG. 3 is a partially schematic isometric view of a powered latch showing possible spring locations for sensors that detect spring failure;

FIG. 4 is a partially schematic isometric view of a mechanical latch showing sensor locations for counting latch cycles; and

FIG. 5 is a partially schematic isometric view of a mechanical latch showing possible spring locations for sensors that detect spring failure.

### DETAILED DESCRIPTION OF THE PREFERRED EMBODIMENTS

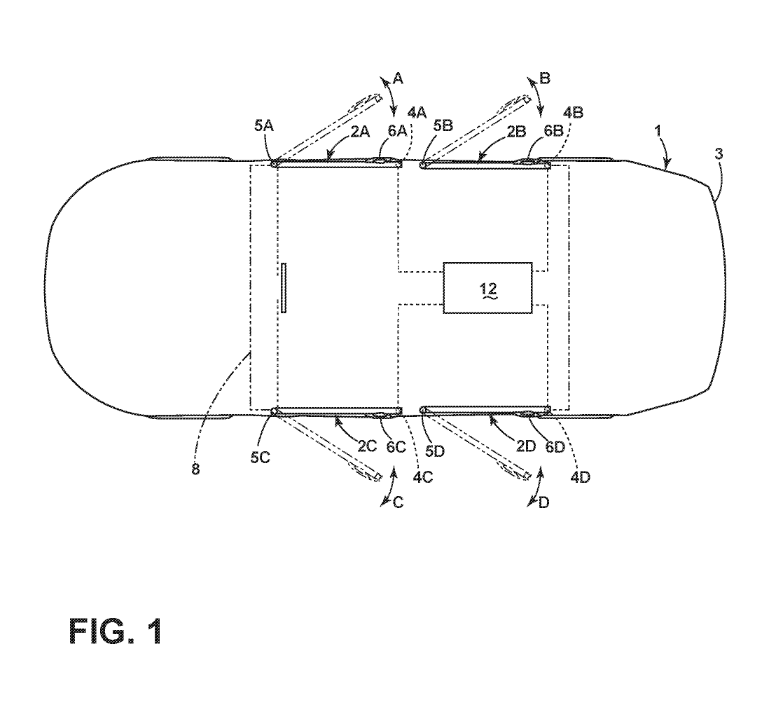

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a motor vehicle 1 may include a plurality of doors 2A-2D that are movably mounted to a vehicle body structure 3 by hinges 5A-5C, respectively for movement between open and closed positions as shown by the arrows A-D. Latches 4A-4D selectively retain the doors 2A-2D in a closed position. As discussed in more detail below, the latches 4A-4D may comprise mechanical latches that are mechanically connected to movable door handles 6A-6D by cables or other suitable linkage whereby movement of the handles 6A-6D unlatches the latches 4A-4D. It will be understood that each door 2A-2D may include both interior and exterior handles that are operably connected to the latches 4A-4D.

Alternatively, the latches 4A-4D may comprise powered latches having electrically powered actuators that shift the latches 4A-4D from a latched configuration to an unlatched configuration. If the latches 4A-4D comprise powered latches, the handles 6A-6D may comprise fixed, non-movable handles having sensors that detect the presence of a user's hand to thereby generate an unlatch request to a controller 12. If the door is in an unlocked state, the controller 12 generates a signal to cause the powered latch to unlatch. The vehicle 1 generally includes an interior space 8, and a user communication device such as a display 10 that is disposed in the interior space 8. As discussed in more detail below, the controller 12 may be configured to generate an audio signal and/or a visual display/message on display 10 to alert a user that one or more of the latches 4A-4D has reached its end-of-life and/or is approaching its end-of-life.

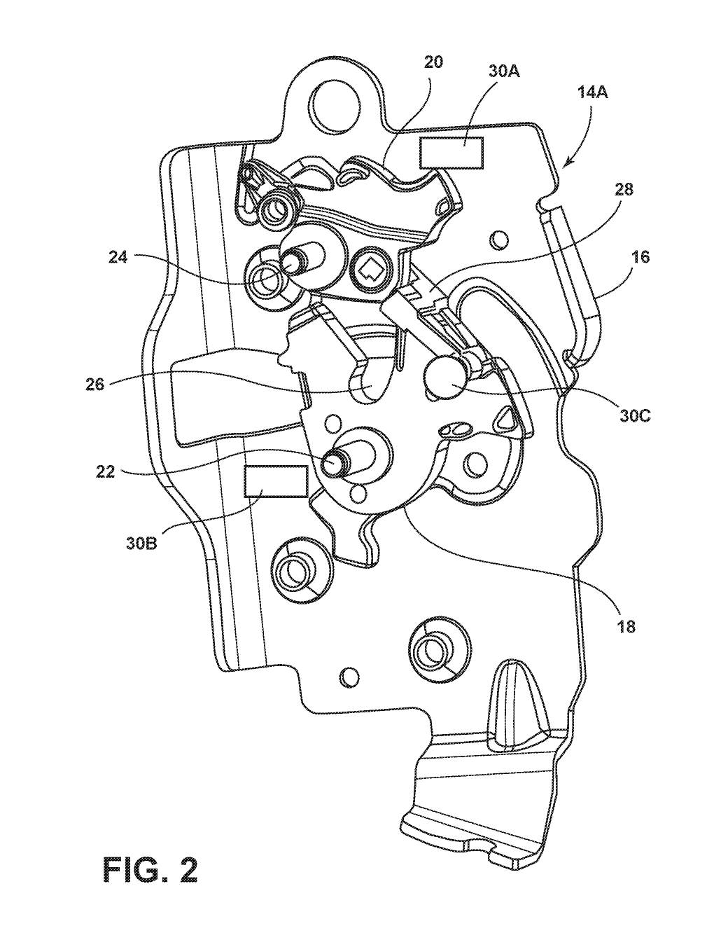

With further reference to FIG. 2, a powered latch 14A includes a support structure such as a bracket 16 and a movable (rotatable) claw 18 that is rotatably mounted to the bracket 16 by a pivot member such as pin 22. A pawl 20 is rotatably mounted to the bracket 16 by a pivot member such as pin 24. The claw 18 includes a slot 26 that is configured to selectively engage a striker (not shown) mounted to the vehicle body structure 3 to selectively retain the doors 2A-2D in a closed position. When latch 14A is in an unlatched configuration, the pawl 20 is disengaged from claw 18 to thereby permit rotation of claw 18. However, when the latch 14A is in a latched configuration, the pawl 20 engages claw 18 to prevent rotation of claw 18. An electrically powered actuator 28 is configured to selectively rotate the pawl 20 between engaged and disengaged positions to thereby unlatch the latch 14A. The powered actuator 28 may be operably connected to the controller 12, and the controller 12 actuates powered actuator 28 upon receiving an unlatch request from one or more sensors on the door, a remote fob, or other user input device. The controller 12 may be configured to unlatch the latch 14A only if the door is in an unlocked state and/or if other predefined operating conditions are present. The basic operation of powered latches including a powered actuator, claw, and pawl are known in the art, and a more detailed description of the operation of latch 14A is therefore not believed to be required. Powered latches are disclosed in U.S. patent application Ser. Nos. 14/468,634, 13/608,303, 14/281,998, 14/282,224, and 14/276,415 the entire contents of each being incorporated herein by reference.

Latch 14A includes one or more sensors 30A, and/or 30B, and/or 30C. Sensor 30A is configured to detect position and/or movement of pawl 20. Sensor 30B is configured to detect position and/or movement of claw 18, and sensor 30C is configured to detect actuation of powered actuator 28 and/or engagement of claw 18 with pawl 20. Sensors 30A-30C may comprise switches, proximity sensors, or other suitable devices. Sensors 30A-30C are shown in schematic form in FIG. 2. It will be understood that the actual form of the sensors 30A-30C will vary depending on the particular sensor/device that is utilized and the configuration of the latch components that are utilized for a particular application. Latch 14A may include only sensor 30A, only sensor 30B, or only sensor 30C. Alternatively, latch 14A may include two of the sensors 30A-30C in any combination, or latch 14A may include all three sensors 30A-30C. The sensors 30A-30C are operably connected to the controller 12, and provide a count of the number of cycles of latch 14A. In general, a cycle comprises movement of claw 18 and pawl 20 from a latched configuration to an unlatched configuration, and back to a latched configuration. Alternatively, a cycle may comprise a change from an unlatched configuration to a latched configuration, followed by a change from the latched configuration to unlatched configuration. Thus, a cycle includes two changes in the latch configuration, namely, a change in the configuration of latch 14A from a latched configuration to an unlatched configuration, and a change in the configuration of the latch 14A from an unlatched configuration to a latched configuration.

Latch 14A may be tested to determine the number of cycles the latch 14A can be used before failure, and the test data can be used to determine a predicted life of the latch 14A. In use, the controller 12 counts the number of cycles and/or changes in configuration, and generates an end-of-life signal when the latch 14A has been used a predefined number of times (e.g. cycles). The predefined number of times may be a number of cycles that corresponds to a predicted end-of-life of latch 14A. The predicted end-of-life of latch 14A may comprise a number that is determined statistically. For example, if numerous latches 14A are tested, a probability of failure as a function of a number of cycles may be developed (e.g. a normal distribution or other suitable/accurate curve), and the end-of-life count utilized to generate the end-of-life signal may comprise a number of cycles at which less than a selected percentage of latches will fail. For example, if testing shows that the latches 14A fail according to a normal distribution curve, the predicted life of the latch may comprise one, two, three, four, or more standard deviations from the median.

The controller 12 may be configured to cause display 10 (FIG. 1) to display a message such as “replace front driver's side latch” or other suitable end-of-life indicator. It will be understood that the vehicle 1 may also, or alternatively include speakers (not shown) that generate an audio message or warning that the end-of-life of the latches has been reached.

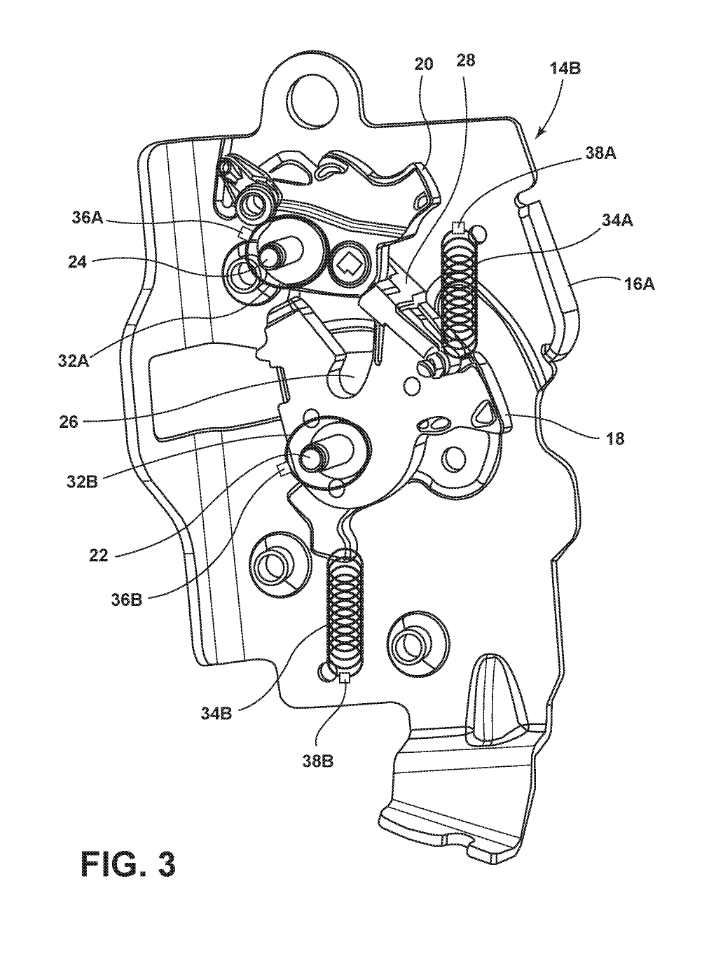

With further reference to FIG. 3, a powered latch 14B according to another aspect of the present invention includes a claw 18, pawl 20, and electrically powered actuator 28 that shifts pawl 20 in substantially the same manner as discussed above in connection with FIG. 2. Powered latch 14B includes one or more torsion springs 32A, 32B and/or one or more compression springs 34A, 34B. Torsion spring 32A is operably connected to a sensor 36A, and the torsion spring 32A is compressed and extended upon rotation of pawl 20. Torsion spring 32A is configured to fail after a predefined number of cycles (i.e. rotations of pawl 20) before or when latch 14B reaches its predicted end-of-life. When torsion spring 32A fails, the failure causes sensor 36 to be actuated, thereby generating a signal to the controller 12. The controller 12 then causes display 10 to display an end-of-life signal. Latch 14B may, alternatively, include a torsion spring 32B and sensor 36B that operate in substantially the same manner as torsion spring 32A and sensor 36A to provide an end-of-life signal.

Latch 14B may include compression spring 34A and/or compression spring 34B that are operably connected to switches or sensors 38A and 38B, respectively. Compression springs 34A and 34B are configured to fail after a predefined number of cycles corresponding to a predicted life of latch 14B to thereby cause switches or sensors 38A or 38B to generate a signal to controller 12 indicating that the latch 14B has reached its end-of-life. Compression spring 34A may be configured to flex upon rotation of claw 18 and/or pawl 20, and compression spring 34B may be configured to extend and compress upon rotation of claw 18. Latch 14B may include a single spring and sensor, or the latch 14B may include two or more springs and sensors.

The spring or springs may be tested to determine a predicted number of cycles at which the spring will fail, and may be designed based on the testing to fail prior to failure of latch 14B based on suitable statistical criteria.

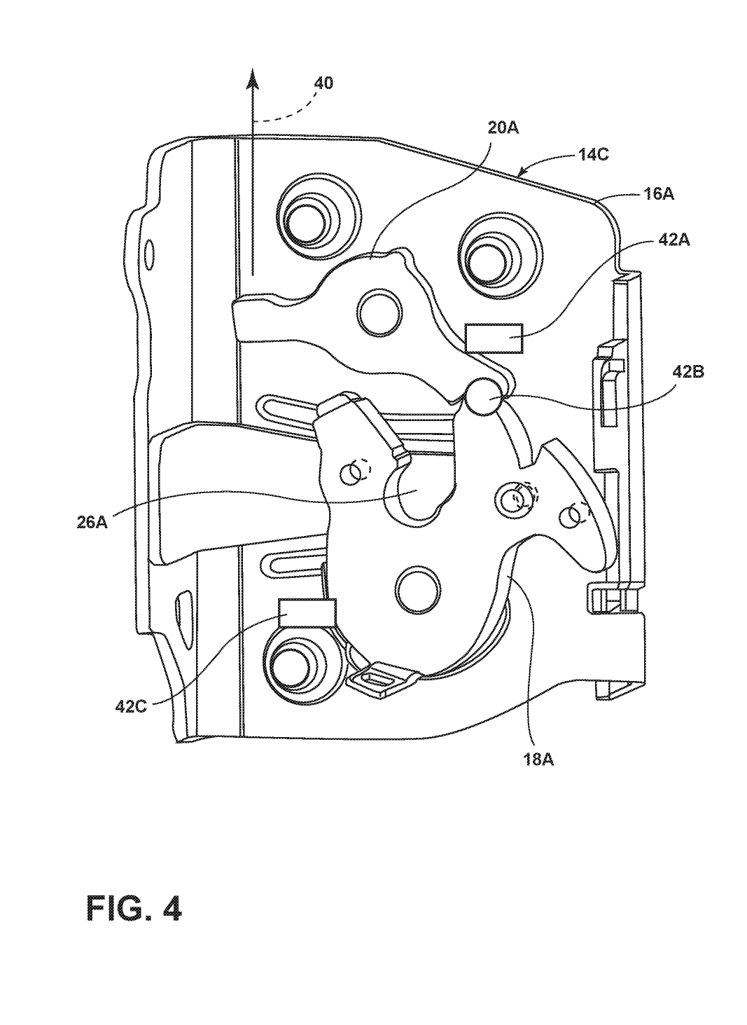

With further reference to FIG. 4, a mechanical latch 14C includes a mounting structure/bracket 16A, and a claw 18A and pawl 20A that are rotatably mounted to the bracket 16A. Claw 18A includes a slot 26A that is configured to selectively engage a striker (not shown) mounted on vehicle body structure 3 to selectively retain a door in a closed position. Pawl 20A is mechanically connected to a door handle 6A-6C (FIG. 1) by a mechanical linkage 40, such that movement of the door handle shifts the pawl 20A from an engaged position preventing rotation of claw 18A to an unlatched configuration permitting rotation of claw 18A. This aspect of latch 14C is known in the art, such that a detailed description is not believed to be required.

Latch 14C includes one or more sensors 42A-42C that are operably connected to controller 12. Sensor 42A is configured to detect position and/or movement of pawl 20A, and sensor 42B is configured to detect engagement of pawl 20A and claw 18A. Sensor 42C is configured to detect position and/or movement of claw 18A. Latch 14C may include one sensor (i.e. one of the sensors 42A, 42B, or 42C), or the latch 14C may include two or more of the sensors 42A-42C.

The sensors 42A-42C generate signals to controller 12 that can be utilized to determine the number of cycles latch 14C has experienced. Controller 12 is configured (e.g. programmed) to generate an end-of-life signal when the number of cycles reaches a number corresponding to predefined end-of-life criteria of latch 14C. The end-of-life criteria may comprise statistical criteria as discussed above. The end-of-life signal generated by controller 12 may cause the display 10 to display a message, or the end-of-life signal may cause the vehicle 1 to generate an audio signal to a user indicating that the latch has reached its end-of-life.

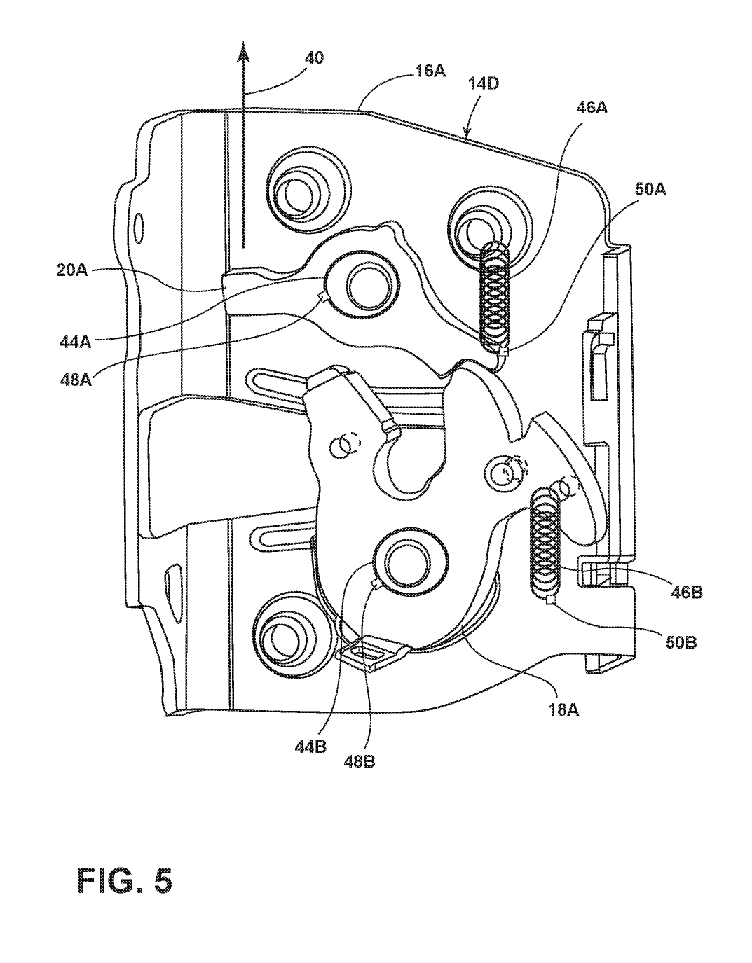

With further reference to FIG. 5, a mechanical latch 14D includes a pawl 20A and claw 18A that operate in substantially the same manner as discussed above in connection with the latch 14C of FIG. 4. Latch 14D may include a torsion spring 44A and sensor 48A, a torsion spring 44B and sensor 48B, a compression spring 46A and sensor 50A and/or a compression spring 46B and sensor 50B. The springs 44A, 44B, 46A, 46B are configured to fail after a predefined number of cycles to thereby cause a sensor 48A, 48B, 50A, or 50B to generate a signal to controller 12. Controller 12 then generates an end-of-life signal, which may cause display 10 to display an end-of-life message to alert a user that the latch has reached its end-of-life. It will be understood that latch 14D may include a single spring and sensor, or it may include two or more springs and sensors.

The door latch system of the present disclosure provides a count device that can be utilized to determine when a vehicle door latch has reached its end-of-life, or is about to reach its end-of-life. This permits the latch to be replaced before the latch reaches its end-of-life and fails.

Although the present disclosure refers to a door latch, it will be understood that the counting device may be utilized to predict the end-of-life of other latches utilized to retain vehicle closure members in closed positions, including latches utilized to retain deck lids, hatches, or hoods of motor vehicles. Still further, the counting device may be utilized in connection with conventional rotating vehicle doors, or it may be utilized in connection with latches for sliding doors utilized in vans or other such vehicles.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A door latch system for vehicle doors, comprising:
a latch for vehicle doors that is configured to shift between latched and unlatched configurations, the latch having a predicted life based on a number of times the latch is used;
a sensor that generates one or more signals that can be used to determine if the latch has reached a predefined end-of-life criteria; and:
wherein the system is configured to generate an end-of-life signal based on the one or more signals from the sensor when the signals indicate that the latch has reached the predefined end-of-life criteria.

2. The door latch system of claim 1, wherein:
the latch includes a rotatable claw that is configured to engage a striker, and a pawl that engages the claw and prevents rotation of the claw when the latch is in a latched configuration; and
the sensor is configured to detect movement and/or position of at least one of the claw and the pawl.

3. The door latch system of claim 1, wherein:
the latch includes a rotatable claw that is configured to engage a striker, and a pawl that engages the claw and prevents rotation of the claw when the latch is in a latched configuration; and
wherein the sensor is configured to detect engagement and/or disengagement of the pawl with the claw.

4. The door latch system of claim 1, including:
a controller operably connected to the sensor, wherein the controller is configured to generate an end-of-life signal when the predefined end-of-life criteria exists.

5. The door latch system of claim 4, including:
a display that is operably connected to the controller; and
wherein the controller causes the display to display a message indicating that the latch has reached its end-of-life and/or that the latch is approaching its end-of-life.

6. The door latch system of claim 1, wherein:
the latch includes a rotatable claw that is configured to engage a striker, and a pawl that engages the claw and prevents rotation of the claw when the latch is in a latched configuration, the latch including an electrically-powered actuator that is configured to shift the pawl between latched and unlatched positions to thereby unlatch the latch; and
the sensor comprises a switch that detects engagement of the pawl with the claw and/or movement and/or position of the claw and/or the pawl.

7. The door latch system of claim 1, wherein:
the latch includes a rotatable claw that is configured to engage a striker, and a pawl that engages the claw and prevents rotation of the claw when the latch is in a latched configuration; and
wherein the latch includes a spring operably connected to the claw and/or the pawl such that the spring cycles upon movement of the claw and/or the pawl, wherein the spring is configured to fail after a predefined number of cycles, and wherein failure of the spring causes actuation of the sensor.

8. The door latch system of claim 7, wherein:
the spring comprises a torsion spring that is operably connected to the claw or the pawl.

9. The door latch system of claim 7, wherein:
the spring comprises a compression spring that is operably connected to the claw or the pawl.

10. A door latch system for vehicle doors comprising:
a latch for vehicle doors having latched and unlatched configurations, wherein, in use, the latch cycles between the latched and unlatched configuration;
a counting device that counts the number of cycles of the latch and/or the number of configuration changes from one of the latched and unlatched states to the other of the latched and unlatched states;
a controller that is operably connected to the counting device, the controller being configured to generate an end-of-life signal indicating that the latch has reached an end-of-life condition and/or is approaching an end-of-life condition, wherein the controller generates the end-of-life signal based on predefined criteria, the predefined criteria comprising at least one of an allowable number of cycles of the latch and/or an allowable number of configuration changes of the latch.

11. The door latch system of claim 10, wherein:
the latch includes a rotatable claw and a pawl that selectively engages the claw to prevent rotation of the claw when the latch is in the latched configuration;
the counting device comprises a switch that engages the claw and/or the pawl.

12. The door latch system of claim 11, wherein:
the latch includes an electrically-powered actuator that shifts the pawl between latched and unlatched configurations.

13. The door latch system of claim 11, including:
a movable door handle that is mechanically connected to the pawl such that movement of the door handle moves the pawl to a disengaged position to unlatch the door.

14. The door latch system of claim 10, wherein:
the counting device comprises a spring that is configured to fail after a predefined number of cycles before the latch reaches the end-of-life condition, and a switch that is actuated when the spring fails.

15. A vehicle latch system, comprising:
a vehicle door latch;
a sensor that detects latch operations including latching and/or unlatching of the latch;
a controller configured to generate an end-of-life signal if the controller determines that a predefined number of latch operations has occurred.

16. The vehicle latch system of claim 15, wherein:
the sensor comprises a switch that is actuated when the latch is latched and/or when the latch is unlatched.

17. The vehicle latch system of claim 15, wherein:
the latch includes a spring that is configured to fail after a predefined number of cycles corresponding to a predicted end-of-life of the latch, and wherein failure of the spring actuates the sensor.

18. The vehicle latch system of claim 17, wherein:
the spring comprises a torsion spring or a compression spring.

19. The vehicle latch system of claim 15, wherein:
the latch includes a rotatable claw and a pawl that selectively engages the claw to prevent rotation of the claw when the latch is in the latched configuration; and
wherein the sensor is configured to sense position and/or movement of the claw and/or the pawl.

20. The vehicle latch system of claim 19, wherein:
the latch includes a powered actuator that moves the pawl from a latched position to an unlatched position.
